(19) United States
(12) Patent Application Publication
(10) Pub. No.: US 2023/0341433 A1
(43) Pub. Date: Oct. 26, 2023

(54) PROGRAMMABLE SEMI-AUTOMATIC AND AUTOMATIC SINGLE OR MULTI-TASK LIQUID EXTRACTION AND PURIFICATION SYSTEM

(71) Applicant: Fluid Management Systems, Inc., Billerica, MA (US)

(72) Inventor: Hamid Shirkhan, Manchester-by -the -Sea, MA (US)

(21) Appl. No.: 18/139,167

(22) Filed: Apr. 25, 2023

Related U.S. Application Data
(60) Provisional application No. 63/334,379, filed on Apr. 25, 2022.

(51) Int. Cl. G01N 35/10; G01N 1/34

(52) U.S. Cl. CPC G01N 35/1009; G01N 1/34

(57) ABSTRACT

A user selectable and programmable multi-task processing system for a liquid extraction and purification system. The system has a multi-pump device to transfer solvents from solvent sources to output lines and multi-tandem column arrays connected to the output lines. The system includes a controller to select solvent sources and multiple associated pumps. Each pump can move solvent from the selected source to an associated output line. The multi-pump device also includes control for each of the plurality of pumps. Each control can selectively enable the associated pump. A timer can operate each enabled pump for a specified duration or to dispense a specified volume of solvent. The system may also include a pressure monitor that monitors pressure in the output lines and triggers an alarm when the pressure exceeds a threshold value. A flow rate selector can select the flow rate at which an enabled pump is to be operated.

### CROSS-REFERENCE TO RELATED APPLICATIONS

This application claims priority from U.S. Provisional Pat. application number 63/334,379 filed Apr. 25, 2022, entitled “Vacuum Liquid Extraction and Purification System and Method”, which application is fully incorporated herein by reference.

### FIELD OF THE INVENTION

The present invention relates generally to liquid extraction and purification and more particularly, relates to an automated single or multi-task system and method for liquid extraction and purification of trace values of unwanted substances from a sample material.

### BACKGROUND OF THE INVENTION

Systems and methods for liquid extraction, purification, fractionation and/or concentration (also referred to herein as extraction and purification) of solvents and solid materials including water, wastewater, serum, milk, food, environmental, biological agricultural and pharmaceutical samples containing trace substances that may be the subject of subsequent analysis or that may be used as an ingredient in a pharmaceutical product are described in various patents. See for example, “Vacuum liquid extraction and purification systems and methods”, to Shirkhan, et al., as U.S. Pat. 10,955,392, issued Mar. 23, 2021, the disclosure of which is incorporated by reference in its entirety.

A liquid extraction and purification system can be used in the extraction, fractionation, purification and/or concentration of a trace substance such as a pesticide, a chlorinated pesticide, a dioxin, a brominated compound, a polychlorinated biphenyl (PCB) and a polybrominated diphenyl ether (PBDE).

The problems with the prior art liquid extraction and purification systems is that they do not utilize automation and cannot be scaled up to perform high throughput sample analysis automatically and unattended.

Accordingly, what is needed is an improved liquid extraction and purification system which is more automated, and easily scaled up to perform a large number of analysis at the same time.

This section is intended to provide a background or context. The description may include concepts that may be pursued but have not necessarily been previously conceived or pursued. Unless indicated otherwise, what is described in this section is not deemed prior art to the description and claims and is not admitted to be prior art by inclusion in this section.

### BRIEF SUMMARY OF THE INVENTION

The below summary is merely representative and non-limiting.

The above problems are overcome, and other advantages may be realized, by the use of the disclosed embodiments and equivalents thereto.

In a first aspect or embodiment, the present invention provides a programable, multi-task processing system for an extraction and purification of target compounds in environmental, biological and food samples. The programable multi-task processing system has a bank of 6 (more or fewer are contemplated) multi-pumps device to transfer solvents from multiple solvent sources to an associated input line 0f a bank of 6 column assembly for purification and fractionation of target compounds. Multi-tandem Snap-in quick connect columns that are assembled arrayed in series are also included. The multi-pump device includes a source selector to select one of the plurality of solvent sources and a plurality of pumps. Each pump can move solvent from the selected solvent source to an associated output line. The multi-pump device also includes a control switch for each of the plurality of pumps. Each control switch can selectively enable the associated pump. A timer can operate each enabled pump for a specified duration to deliver precise volume at specified flow rate. The multi-pump device also includes a pressure monitor that monitors pressure in the output lines and triggers an alarm when the pressure exceeds a threshold value. A flow rate selector can select one of a plurality of flow rates at which each enabled pump is to be operated. for each pump of the plurality of pumps, an indicator signal to alert the user in response to pressure in an associated output line exceeding a threshold value. The indicator signals may be LED lights, an LED or LCD display and/or alarms sounds. The multi-pump device can pause operation of all pumps in response to pressure in any output line exceeding the threshold value.

In another aspect, a second embodiment of the invention provides a column element for use to perform selective extraction and purification of target compounds. The column element includes a first end fitting disposed at a first end and a second end fitting disposed at a second end. A body of the column element defines a column element interior cavity extending between the first end fitting and the second end fitting. The column element also may include multiple layers; first material layer and a second material layer which are separated by an interior glass frit disposed between the first material layer and the second material layer.

In a further aspect, an embodiment provides a method of operating a multi-pump device for an extraction and purification of target compounds.. The method includes using a source selector to select a first solvent source of a plurality of solvent sources and selecting at least one pump to move first solvent from the selected solvent source to an associated output line. A flow rate selector is set in order to select one of a plurality of flow rates at which each enabled pump is to be operated.

A volume measurement controller or specified duration for a timer is set so as to operate the selected at least one pump for the specified duration. An output line is attached to sample cartridge and assay columns. The method also includes activating the multi-pump device so that the selected at least one pump performs a single extraction and or purification process task using at least one sample and one column.

The invention features a programable, semi-automatic and automatic single or multi-task liquid extraction and purification system, comprising at least one solvent source. A programmable controller is fluidly coupled to the at least one solvent source, the programmable controller configured for being pre-programmed program or manually programmed to selectively control the selection of the at least one solvent source and for the provision of the selected at least solvent source under one or more of a user programmable flow rate, time duration and pressure. At least one column array is fluidly coupled to the controller. The at least one column array comprises at least one sample containing cartridge fluidly coupled to at least one column element, the at least one column element containing at least one material for use in processing the sample in the sample containing cartridge.

In one embodiment, the system includes a plurality of differing solvent sources and may further include a nitrogen source and a two-way valve, fluidly coupled to the nitrogen source and to the at least one solvent source, and electronically coupled to the controller. The two way valve is configured for being controlled by the controller to selectively allow one or the other of the nitrogen from the nitrogen source or the solvent from the at least one solvent source to the at least one sample containing cartridge which forms part of the at least one column array.

In another embodiment, the at least one column array includes the at least one sample containing cartridge fluidly coupled to a plurality of column elements containing at least one material for use in processing the sample in the sample containing cartridge, each of the plurality of column elements including an input end and an output end. The at least one column array may include a nitrogen source and a first two way valve, fluidly coupled to the nitrogen source and to the at least one solvent source, and electronically coupled to the controller. The two-way valve is configured for being controlled by the controller to selectively allow one or the other of the nitrogen from the nitrogen source or the solvent from the at least one solvent source to the at least one sample containing cartridge which forms part of the at least one column array. The additional embodiment may also include

a first column element containing at least one material for use in processing the sample in the sample containing cartridge, the first column element including an input end and an output end and a second two way valve, fluidly connected between an output end of the sample containing cartridge and the input end of the first column element and to at least one of the nitrogen source or the at least one solvent source, the second two way valve electronically coupled to the controller, and configured for being controlled by the controller to provide at least one of the nitrogen source or the at least one solvent source to the input end of the first column element.

A third two-way valve may be provided, fluidly connected between an output end of the first column element and to one or more of a material collection vessel or a waste vessel, and configured for being controlled by the controller to provide an output from the output end of the first column element to one of the material collection vessel or the waste vessel.

In the preferred embodiment, the at least one column array includes the at least one sample containing cartridge fluidly coupled to a first column element, the first column element containing at least a first material for use in processing the sample in the sample containing cartridge, and wherein the first column element is fluidly coupled to at least a second column element containing at least a second material, different from the first material in the first column element, for use in processing the sample in the sample containing cartridge.

In another embodiment, the at least one column element in the at least one column array contains both first and second materials for use in processing the sample in the sample containing cartridge. The first and second materials are separated by a fluid material permeable divider.

In the preferred embodiment, the at least one column element includes a first end and a second end, wherein one of the first and second ends is closed by one of a male or a female fitting, and wherein the other of the first and second ends is closed by the other one of the male or female fitting. The at least one column element and the sample containing cartridge may be disposable.

In the preferred embodiment, the system includes a plurality of solvent sources, and wherein the programmable controller is fluidly coupled to the plurality of solvent sources and configured for being pre-programmed using a stored program or manually programmed to selectively control the selection of the at least one solvent source from one of a plurality of solvent sources and the provision of the selected at least solvent source under one or more of a user programmable flow rate, volume, time duration, and pressure.

In a further embodiment, the at least one column element comprises a polytetrafluoroethylene (PTFE) tube body, the tube body defining a column element interior cavity extending between a first end and a second end of the PTFE tube. A first fitting is disposed at the first end of the PTFE tube a second fitting disposed at the second end of the PTFE tube. The column element may further include a first glass frit disposed at the first end fitting of the PTFE tube, a second glass frit disposed at the second end fitting of the PTFE tube and at least a first material layer disposed within the PTFE tube interior cavity. The first fitting is preferably one of a male luer fitting or a female luer fitting and wherein the second fitting is one of a male luer fitting or female luer fitting. The first and second fittings may be permanently pressed into the body of the (PTFE) tube and are integral with the body of the PTFE tube.

In the preferred embodiment, the at least a first material in the column element may be selected from the group of materials consisting of silica, carbon and alumina. In another embodiment, the PTFE tube interior includes first and second material, the first and second materials separated by a material separation frit.

The invention also includes a method of operating a programable, semi-automatic and automatic single or multi-task liquid extraction and purification system. The method comprises the acts of providing a programable, semi-automatic and automatic single or multi-task liquid extraction and purification system comprising a plurality of solvent sources and a programmable controller, fluidly coupled to the at least one solvent source, the programmable controller configured for being pre-programmed program or manually programmed to selectively control the selection of the at least one solvent source and for the provision of the selected at least solvent source under one or more of a user programmable flow rate, time duration and pressure. At least one column array is provided and fluidly coupled to the controller, the at least one column array comprising at least one sample containing cartridge fluidly coupled to at least one column element, the at least one column element containing at least one material for use in processing the sample in the sample containing cartridge.

The method further comprises using the programmable controller to select a first solvent source from a plurality of solvent sources, the act of using the controller to select a first solvent source from the a plurality of solvent sources including the controller operating a valve coupled to the first solvent source. The programmable controller is used to select at least one pump configured to move the selected first solvent from the selected first solvent source to an associated output line while the programmable controller is used to select a flow rate for at least one pump for the first solvent. The programmable controller is also used to set at least one of a specified time duration or a specified solvent volume for which the at least one pump will operate. The method further includes attaching an output line from the programmable controller to an assay column array; and using the programmable controller, activating the at least one pump to perform a single purification process task.

The purification process task of the method may comprise one or more of the following steps including conditioning one or more assay column arrays, sample loading of one or more assay column arrays, purification and removal of interferences in the one or more conditioned and sample loaded assay column arrays and collecting fractions from the one or more assay column arrays.

The step of conditioning, sample loading, purification and fraction collection may be performed one task at a time using one or more assay column arrays and includes the acts of assembling at least one sample cartridge, assembling at least one column array including the assembled sample cartridge and further including a plurality of column array elements, each column array element containing one or more of silica, alumina and carbon. For each of the assembled column arrays, the method includes attaching an output line of an associated solvent pump to a first column element of an assembled column array, activating the associated solvent pump to move a selected solvent from a selected first solvent source to an associated output line and conditioning the column array using the first solvent.

In another aspect of the invention the act of sample loading comprises attaching an output line of a nitrogen or solvent pump to the at least one sample containing cartridge and using one or both of the nitrogen or solvent pump to transfer the samples from the sample cartridge to the column array. The act of purification may comprise attaching a pump output line to each of a plurality of silica containing assay column elements and activating at least one pump device to move solvent through the plurality of assay column elements.

The invention also features a sample cartridge reservoir comprising a cartridge tube, a embedded male fitting at a first end of the cartridge tube, and a removable cartridge cap at a second end of the cartridge tub. The removable cartridge cap preferably includes a o-ring seal. The cartridge includes a body defining a cartridge element interior cavity extending between the first end and the second end and a first frit disposed at the first end proximate the embedded male fitting. In one embodiment, the embedded male fitting is a male luer fitting while the removable cartridge endcap fitting is a female luer fitting.

In the preferred embodiment, the removable cartridge cap with associated o-ring seals the cartridge by placing the endcap over the second end of cartridge and twisting the end cap approximately 90 degrees.

### BRIEF DESCRIPTION OF THE SEVERAL VIEWS OF THE DRAWINGS

In the present invention the following two configuration are described:

Semi-automatic extraction and purification performing multiple steps in one task wherein the steps can be manually programed as a single task at the beginning of each run, and an automated multiple task extraction and purification methos and system which performs multiple tasks sequentially and automatically using a multitask program saved in system memory.

These and other features and advantages of the present invention will be better understood by reading the following detailed description, taken together with the drawings wherein:

FIG. 1 is a block diagram of the programable semi-automatic and automatic single or multi-task liquid extraction and purification system according to the present invention;

FIGS. 2A and 2B are a view of the system controller and control panel respectively according to one aspect of the present invention;

FIG. 2C is a view of the sample processing portion of the system according to the present invention;

FIG. 2D is a detailed diagram of a multi-channel automated sample cleanup for Dioxins and PCBs analysis which includes the system controller, control panel and sample processing portions of the system according to the present invention including plumbing connections required according to one embodiment of the invention;

FIG. 2E is a simplified diagram of the plumbing connections required for the embodiment of the present invention shown in FIG. 2D;

FIG. 2F is a view of a system diagram for multi-channel automated sample clean up and EPH analysis, according to one method for use of the system of the present invention;

FIG. 2G is a simplified diagram of the plumbing connections required for the embodiment of the present invention shown in FIG. 2F;

FIGS. 3A-3L are diagrams illustrating various column elements, element sizes, shapes and end caps;

FIGS. 4A and 4B are detail views of one embodiment of the sample cartridge end caps according to one aspect of the invention;

FIGS. 5A and 5B are exploded perspective and cross-sectional views of a column element loaded with a single material;

FIGS. 6A and 6B are exploded perspective and cross-sectional views of a column element loaded with two materials separated by a frit or other element;

FIGS. 7A-7C are perspective and cross-sectional views of a male luer according to one aspect of the present invention;

FIGS. 8A-8C are perspective and cross-sectional views of a female luer according to one aspect of the present invention; and

FIGS. 9A and 9B are diagrams illustrating unassembled and assembled column elements respectively.

### DETAILED DESCRIPTION OF THE INVENTION

Various embodiments of the invention disclosed and described herein provide a programable, semi-automatic, or fully automatic, single or multi-task liquid extraction and purification system.

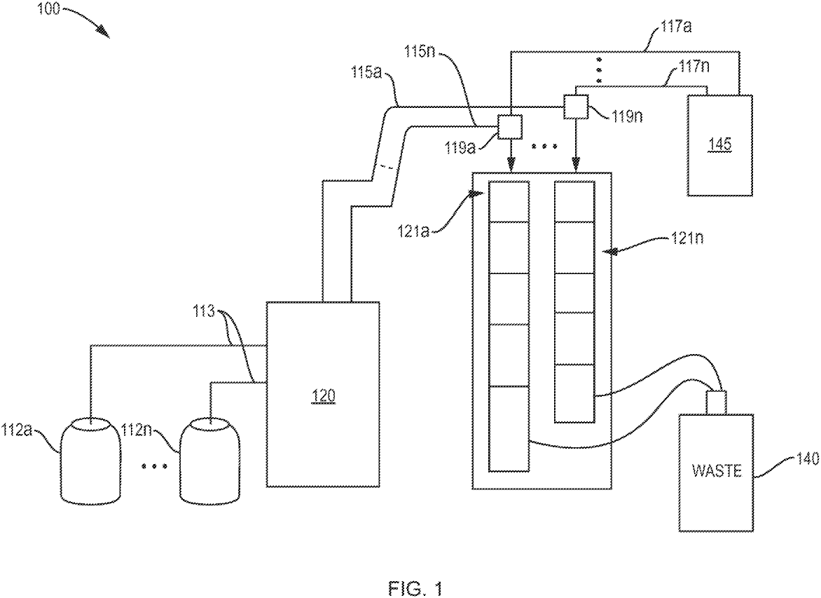

The extraction and purification system 100, FIG. 1, according to the present invention, includes one or more (preferably multiple) solvent sources 112 coupled to a controller 120. The controller 120 is user programmable and may run a pre-programmed program or manually individually programmed to selectively control the selection of one of a plurality of solvent sources (or nitrogen or other inert gas), and the provision of the solvent (or nitrogen) under a user programmable flow rate, time and pressure, for example, to the sample column array 130 containing one or more (preferably multiple) array columns as will be explained in greater detail below by means of tubing 112 and 115. Any waste from the column array after processing a sample is routed to a waste container/receptacle 140. Controller 120 also controls the provisions of nitrogen or other similar inert gas from nitrogen source 145 to the sample column array 130 by means of hoses or tubing 117. A number of two-way valves 119 are controlled by the programmable controller 120 and are utilized to selectively and at times sequentially control the provision of either solvent from one or more solvent sources 112 or nitrogen 145 or other inert gas.

The programable, semi-automatic, and automatic single or multi-task extraction and purification system uses a multi-pump device in the controller 120 to transfer a selected one or more solvents 112 from multiple solvent sources 112 by means of an associated output line 113. The controller 120 then delivers the selected solvent to one or more sample cartridges and column arrays 121 found in the sample column array 130. Multiple tandem column elements (as will be explained in greater detail below) are assembled so as to be arrayed in series along with a sample cartridge (collectively termed a column array herein) and are used to process a sample. The controller 120 allows the user to select and program the selection of one of a plurality of solvent sources 112 to be provided to a particular column array via one or more solvent pumps. Each pump can move solvent from the selected solvent source 112 to an associated output line 113, 115 and to a selected column array 121. The controller 120 includes a control switch for each of the plurality of pumps. Each control switch can be programmed to selectively enable the associated pump. A timer can operate each enabled pump for a specified duration. The system 100 also includes a pressure monitor that monitors pressure in the output lines 113, 115 and 117 and triggers an alarm when the pressure exceeds a threshold value. A flow rate selector can be programmed to select one of a plurality of flow rates at which each enabled pump is to be operated.

By selecting which solvent 112 is to be used and how much to be provided, the column arrays 121 can be conditioned and used for sample processing. Each process step can include resetting the multi-pump device to select the solvent to be used, the flow rate and the duration or volume. The columns may be assembled (and reassembled) so that the sample is properly processed, for example, by removing unwanted compounds sending it to waste 140 and/or moving the desired extracted elements for collection. Using the programable, semi-automatic, multi-task processing system 100, the system 100 can operate without repeated washing or changing of tubes. This can speed up the extraction and purification process and reduce the chance of error.

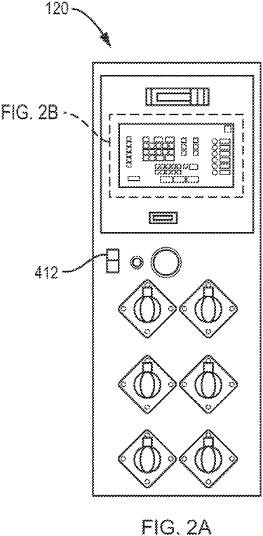

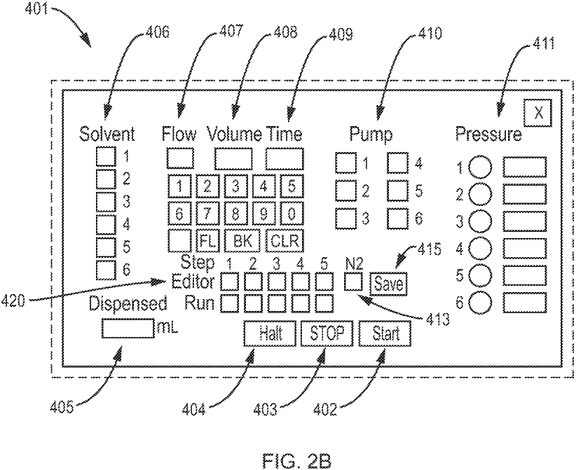

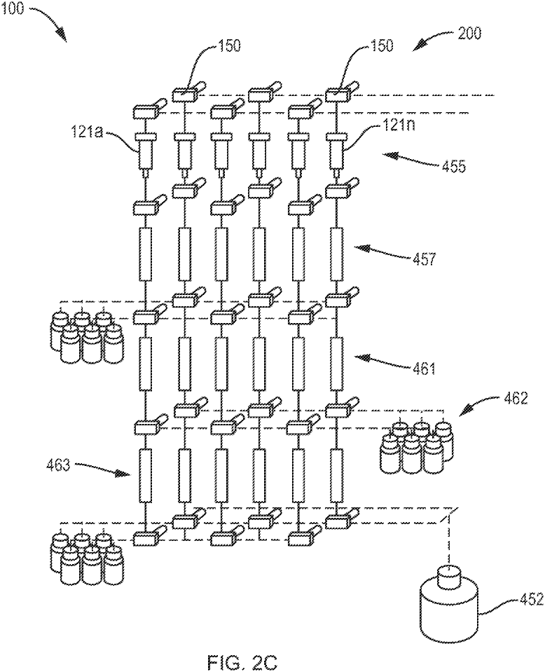

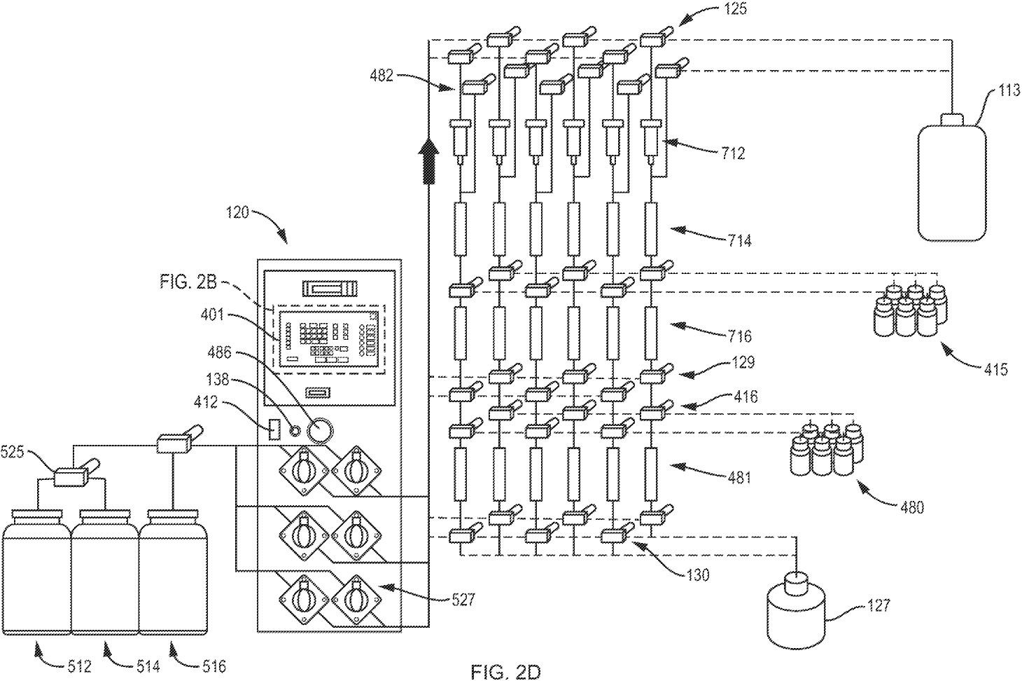

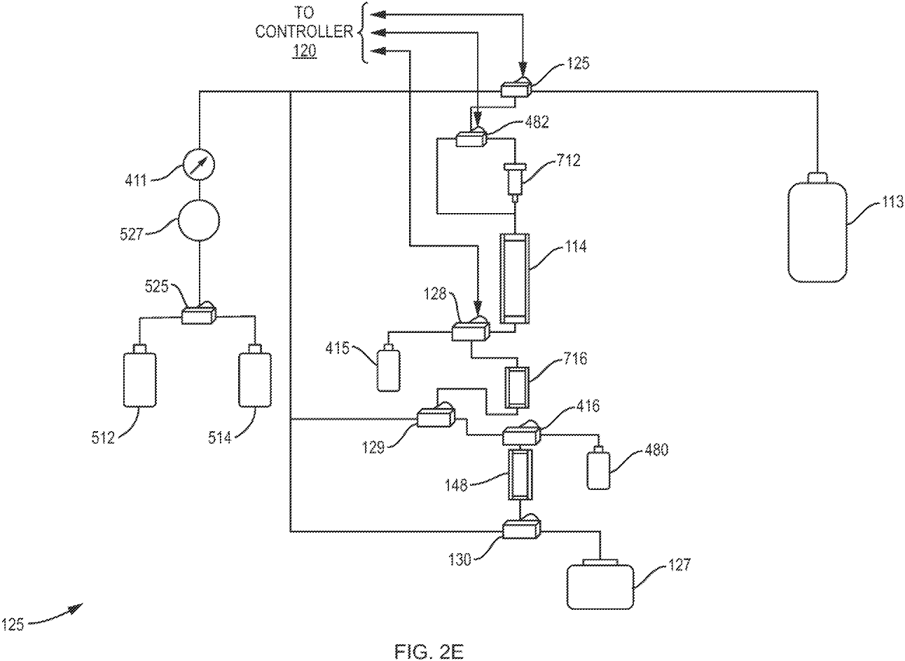

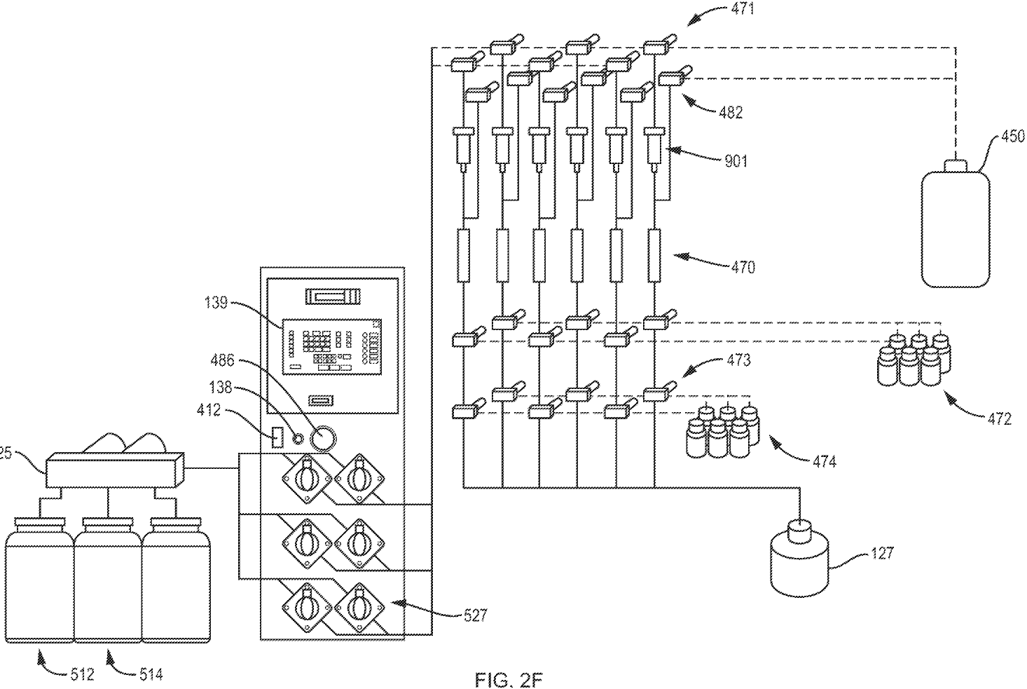

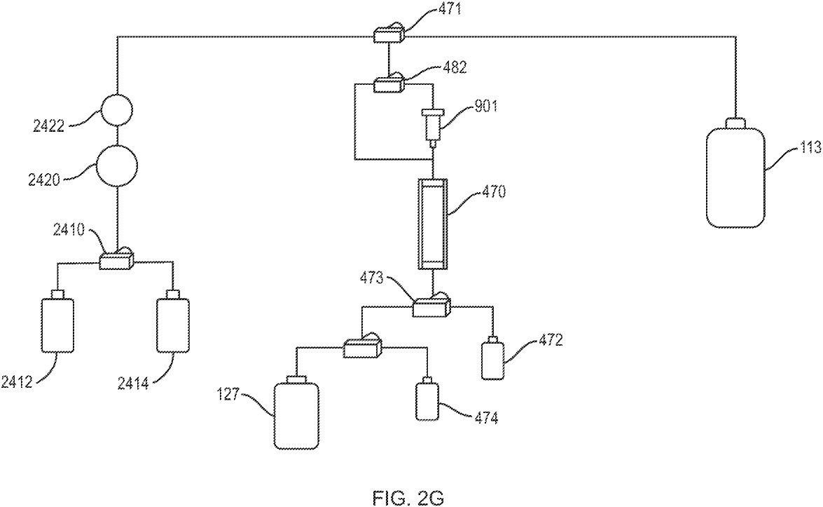

FIG. 2C illustrates an automated universal extraction & purification system 100 according to a preferred embodiment of the present invention, and which can process six (6) samples simultaneously using and as programmed by controller 120, and the sample processing system 200. Control panel 401, FIGS. 2A and 2B, allows programming of multi tasks to control and establish the desired extraction, purification and cleanup process. Sample cartridges 455, chromatography columns 457, flow rate 407, volume 408, and pump enable/disable switches 410 are programmed as tasks in and using the control panel 401.

Programmable tasks also include the selection of multiple column arrays 121 through selecting one or more multiple valves 150 to control and select a collection vessel or waste bottle. Column elements 714, 716 and 481 together form a column array 121. During the operation of the programmed and selected task, control panel 401 displays column array pressures 411, solvent dispensed volume 405, and the time elapsed 409. The program can be halted or paused temporarily using halt button 404 and restarted by selecting the start button 402 to restart the process or task at the point at which it was halted. The program can be stopped by selecting button 403. Button 413 may be used to select nitrogen while button 415 is provided to save the selected program and parameters for future use, eliminating the need to program the controller each time for repetitive tasks. Editor button 420 allows a previously stored program to be edited. The unique design of the system 100 of the present invention allows the system 100 to automate any and all extraction and purification processes with pumps and network of simple two-way valves 150. The system 100 can be configured to perform a simple extraction using one column per sample, or perform multi column applications. As an example, the following application includes one column purification and cleanup for EPHs and multiple column array purification and cleanup for Dioxin and PCBs.

FIG. 2D illustrates close up view of six (6) parallel sample cleanup and fractionation of Dioxins and PCBs from variety of different samples. In controller module 120, power switch 412, nitrogen pressure regulator 138, nitrogen pressure gauge 486 and control panel 401 are the components of the controller module 120.

In this application, the control panel 401 is used to create and run a multi-task program required to perform the Dioxin and PCBs sample clean up. There are 5 tasks required to perform this sample cleanup. Task-1 column conditioning; Task-2 sample injection; Task-3 diluting of the target analytes through a silica column; Task-4 dioxin fraction collection; and Task-5 PCB fraction collection.

FIG. 2E illustrates a one-line plumbing diagram of FIG. 2D for Dioxin and PCB cleanup and fractionation.

The Task-1 conditioning of the column elements (column elements 714, 716 and 481 which together form a column array 121) is performed by selecting the flow rate and volume for pump 527, drawing solvent Hexane 512, through solvent valve 525, through pressure sensor 411, and selecting the solvent port in the solvent/nitrogen valve 125, bypassing sample cartridge 712 by selecting bypass valve 482, through silica columns 114, through valve 128, through carbon column 716, through valve 129, through valve 416, through alumina column 148, through valve 130 to waste 127. All of this selection and control process is done using programmable controller 120.

Each column element may include material to process the sample to, for example, remove undesired chemicals, filter physical contaminants, and/or to extract the desired substance. By assembling the column array with different column elements, the sample may be processed differently based on the desired results. Once the column is assembled, the bottom element may be placed on a manifold and the column secured by column clips. Depending on the process to be performed, the column may be connected at the top to a solvent connector or a nitrogen connector or to a two-way valve connected to both a solvent source and a nitrogen source and selectively programmable to provide one or the other of a solvent or nitrogen or other gas to the column array.

The controller 120 is programmable controller comprising a specialized micro controller used to control various components of the system 100. The components of the programmable controller 120 include a power supply; micro controller and an input/output (I/O) section. Such hardware is well known in the art. The input section of the programmable controller can be found on the control panel 401.

Task-2 sample injection, using nitrogen 113, begins by have the controller 120 select nitrogen port on two-way valve 125, and valve 482 through the sample cartridge 712, thereby pushing the sample in the sample cartridge through silica column 114 through valve 128, through carbon column 716, through valve 129 and valve 416, through alumina column 148, and through valve 130 to waste 127, all under program control of controller 120.

Task-3 to elute the analyte of interest, the pump 527 draws solvent Hexane 512 through solvent valve 525, through pressure sensor 411, and then selecting the solvent port in solvent/nitrogen valve 125, whereby the solvent flows through sample cartridge 712 by selecting 482 valve, through silica column 114, through valve 128, through carbon column 716, through valve 129, through valve 416, through alumina column 148, and through valve 130 to waste 127.

Task-4 is to collect purified Dioxins fractions, using pump 527, and selecting solvent valve 525 to draw Toluene solvent 514 through valve 129 in a reverse direction through carbon column 716, through valve 128, and then collecting in the dioxin fraction vessel 415.

Task-5 to collect purified PCB fractions, using pump 527. Solvent valve 525 draws Toluene solvent 514 through pressure sensor 411, through valve 130, in reverse direction through alumina column 148, through valve 416 thereby collecting the PCBs in fraction in PCB fraction vessel 480.

FIG. 2F illustrates a closeup view of six (6) parallel column array sample cleanup for the isolation and fractionation of EPHs. This application uses just one column array element (silica) to perform sample cleanup to purify and fractionate Aliphatic and Aromatic hydrocarbons and collect these in separate vessels.

FIG. -2G illustrates one-line plumbing diagram of FIG. 2F for sample cleanup of EPHs, purifying, isolating and fractionating Aliphatic and Aromatic hydrocarbons, and collecting these in separate vessels.

There are 4 tasks required to perform the sample clean up, isolation and fractionation of Aliphatic and Aromatic hydrocarbons. Task-1 conditions the silica column 470 specifying flow rate and volume for the solvent using pump 2420 and then subsequently drawing hexane 2412 by selecting solvent valve 2410, through pressure sensor 2422 through solvent nitrogen valve 471 selected to solvent, bypassing sample cartridge 901, through silica column 470, through valve 473 to waste bottle 127.

Task-2 to inject the sample into the silica column, using nitrogen 113 (and not solvent), through nitrogen valve 471 and through valve 482, through sample cartridge 901 pushing the sample to silica column 470, through valve 473 to waste 127.

Task-3 is to collect aliphatic hydrocarbons, wherein pump 2420 is selected to draw solvent hexane 2412 through solvent valve 2410, passing through pressure sensor 2422, through valve 471 and valve 482 through silica column 470 through valve 473, to collect aliphatic hydrocarbon fractions in collection vessel 472.

Task-4 is to collect aromatic hydrocarbons, wherein pump 2420 is selected to draw solvent DCM (Dichloromethane) 2414 through solvent valve 2410, passing through pressure sensor 2422, through valve 471 and valve 482 through silica column 470 through valve 473, to collect aromatic hydrocarbon fractions in vessel 474.

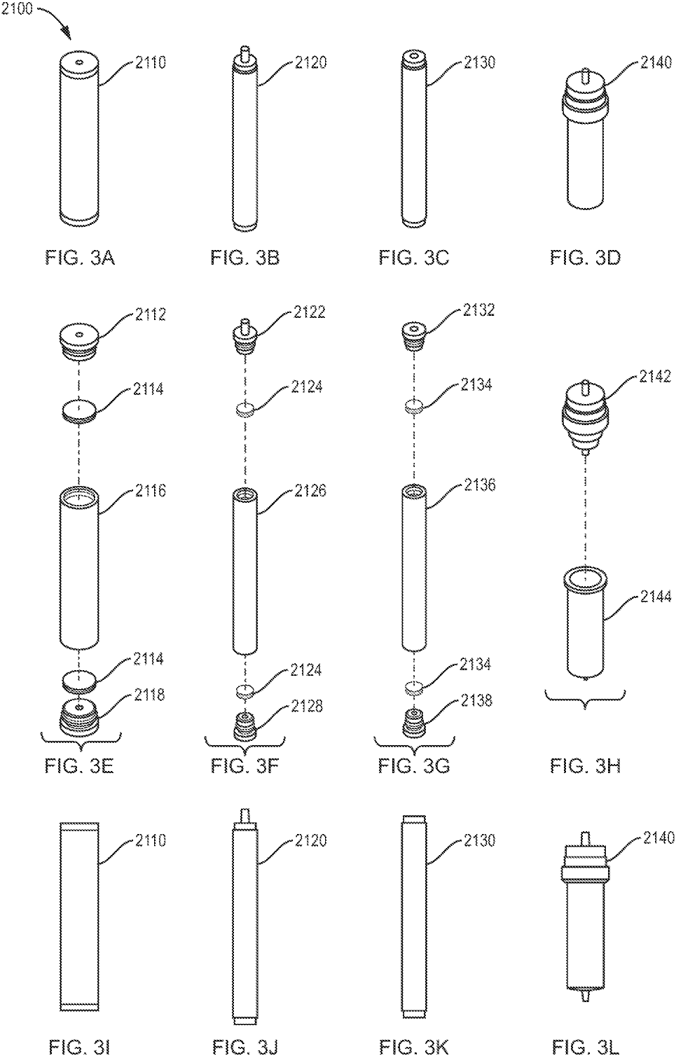

FIG. 3 shows various column elements 2100. As shown, there are 4 styles of column elements - large column element 2110, narrow column element 2120, narrow column element 2130 and sample reservoir or cartridge 2140. In alternative embodiments, the column elements may be of other thickness, sizes, shapes and styles. Likewise, the column element may be circular in cross-section and/or may have other shaped cross-sections, for example, hexagonal.

The large column element 2110 typically includes a female luer connector 2112 at the upper end. The female luer 2112 is secured within column element body 2116 and a frit 2114 is disposed adjacent to the female luer 2112. At the bottom end, a female luer connector 2118 and adjacent frit 2114 are disposed so as to cap off the column element 2116.

The narrow column element 2120 is disposed similarly to the large column element 2110 except that a male luer 2122 may be located at the upper end and appropriately sized frits 2124 within column element body 2126. In an alternative embodiment, the male/female luers 2112/2122 may be exchanged with the opposite type. In such cases, the female luer connector 2118 may be replaced with a male end luer. Narrow column element 2130 demonstrates this concept with female luer 2132 replacing male luer 2122. Additionally, narrow column element 2130 includes frits 2134 and washer ring 2135 all sized and designed to fit within column element body 2136.

The sample reservoir cartridge 2140 may vary in size, with a removable end cap 2142 which includes a male or female luer style end formed to fit the cartridge body 2144.

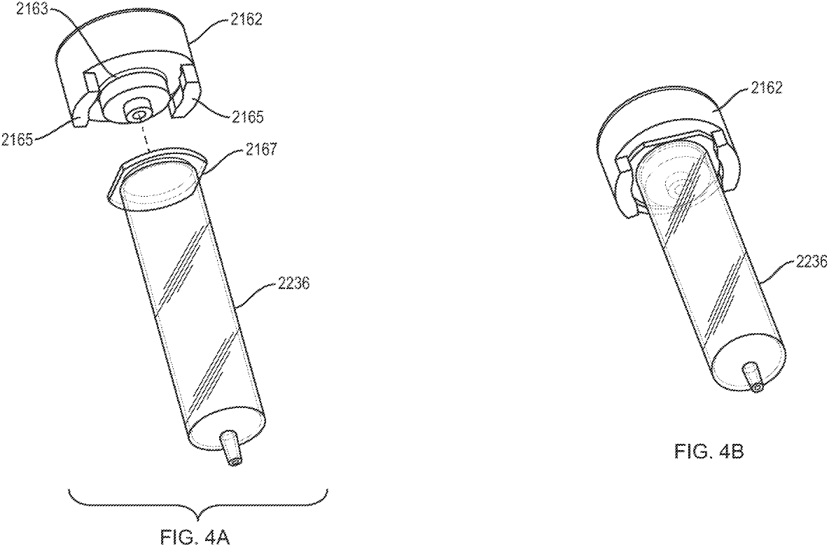

In another embodiment of sample reservoir cartridge unit 2160, FIGS. 4A and 4B, the sample cartridge 2160 may be provided with removable end cap 2162 and “o” ring seal 2163 which seals the cartridge body 2236 by placing the cap 2162 on the cartridge 2236 such that the tabs 2165 on the cap 2162 slide over the flat areas 2167 in the cartridge 2236 and then subsequently twisting the cap 2162 90 degrees to lock the cap 2162 onto the cartridge 2236. The cap 2162 may have a male or female luer style end connection.

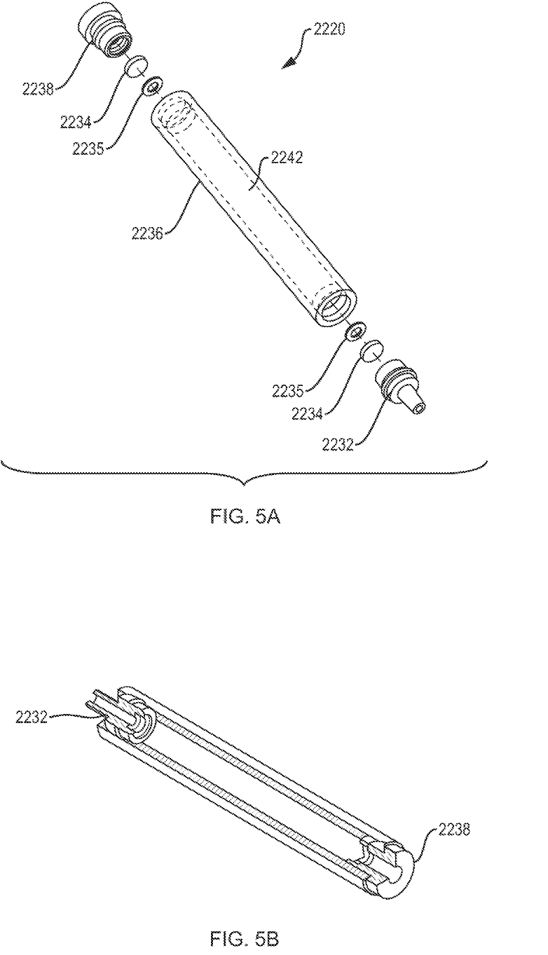

FIGS. 5A and 5B show an exploded and cut-away view respectively of aa exemplary single packed column element 2220. The column element 2220 has a column body 2236 with a male luer end fitting 2232 which contains frit 2234 and retaining washer 235 disposed at one end, and a female luer end fitting 2238 which contains frit 2234 and retaining washer 235 at the other end.

Between the two frits 2234 is a packed material 2242. The packed material 2242 may be selected so as to purify or extract compounds moving through the column unit 2220. This packed material 2242 may include, but is not limited to, silica, carbon, alumina, etc.

The frits 2234 may be made of various materials, such as Polytetrafluoroethylene (PTFE) available under the brand name Teflon® and stainless steel. The frit materials may also be filter materials such as glass, cotton or wool.

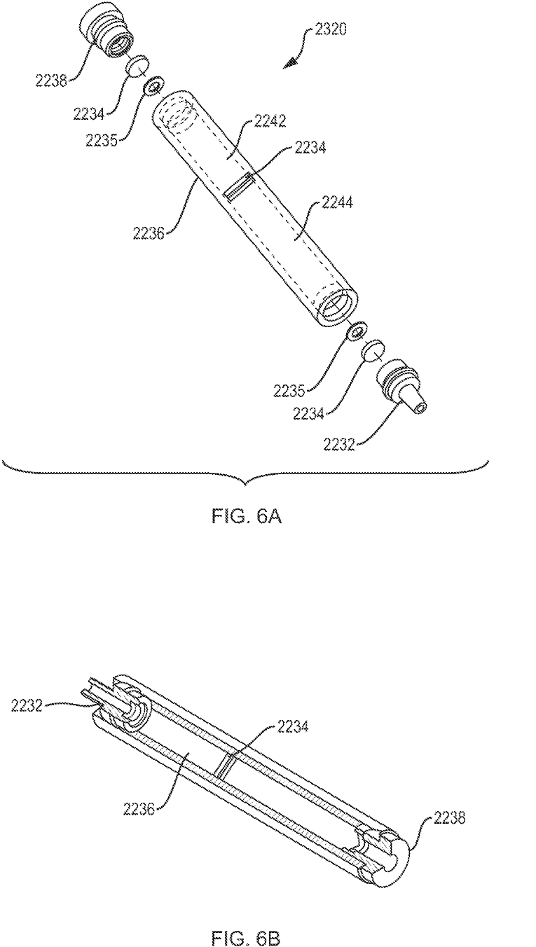

FIGS. 6A and 6B show an exploded and cut-away view of an exemplary multiple packed column unit 2320. The multiple packed column unit 2320 includes a column body 2336 housing a first packed material 2342 and a second packed material 2344 which are separated by frit 2334. At the ends are a male luer 2332 and female luer 2338, each with an associated frit 2334.

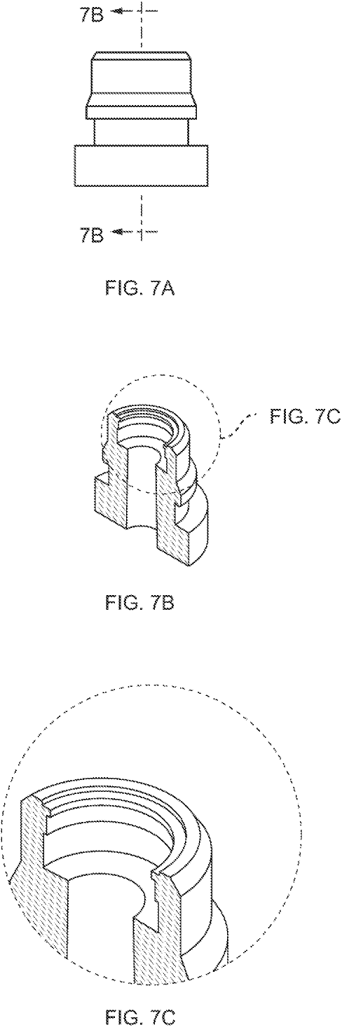

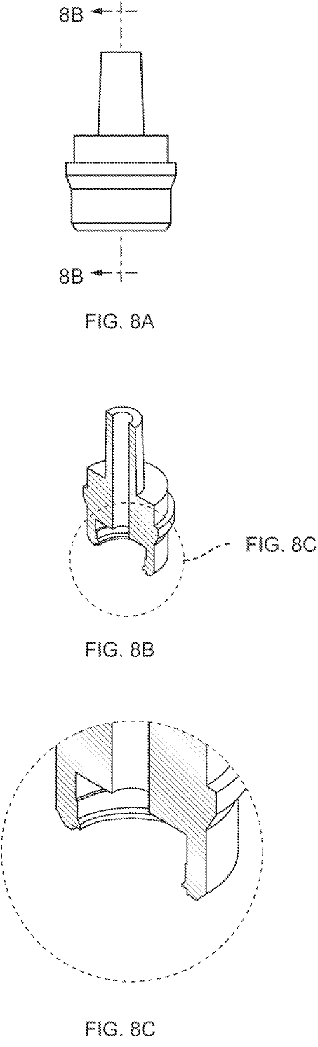

FIGS. 7A-7C show a perspective and a cut-away view of a female luer end fitting while FIGS. 8A-8C show a perspective and cut-away view of a male luer end firring.

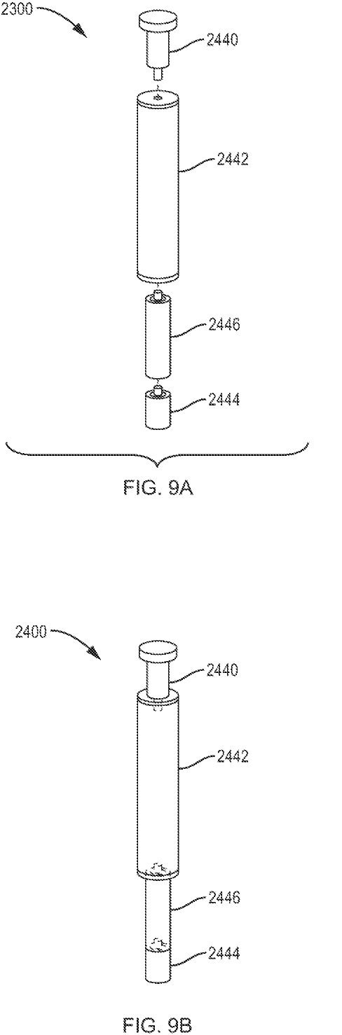

FIGS. 9A and 9B illustrate an unassembled column array 2300 FIG. 9A comprising, for this illustration, sample cartridge 2440, column elements 2442, 2444 and 2446 while FIG. 9B illustrates the sample cartridge 2440 and column elements 2442, 2444 and 2446 as an assemble column array 2440.

Various embodiments provide a, semi-automatic, multi-task processing system for an extraction and purification system. The programable, semi-automatic, multi-task processing system has a multi-pump device to transfer solvents from multiple solvent sources to an associated output line. Multi-tandem columns which are assembled so as to be arrayed in series. The multi-pump device includes a source selector to select one of the plurality of solvent sources and a plurality of pumps. Each pump can move solvent from the selected solvent source to an associated output line. The multi-pump device also includes pump enable switch for each of the plurality of pumps. Each control switch can selectively enable the associated pump. A timer or volume controller can operate each enabled pump for a specified duration. The multi-pump device also includes a pressure monitor that monitors pressure in the output lines and triggers an alarm when the pressure exceeds a threshold value. A flow rate selector can select one of a plurality of flow rates at which each enabled pump is to be operated.

In another embodiment of any one of the programable, semi-automatic, multi-task processing systems above, the multi-pump device includes a flow rate selector to select one of a plurality of flow rates at which each enabled pump is to be operated. An amount of solvent to be moved by a pump through the associated output line is determined by the selected flow rate and the specified duration.

In a further embodiment of any one of the programable, semi-automatic, multi-task processing systems above, the multi-pump device includes, for each pump of the plurality of pumps, an indicator signal to alert the user in response to pressure in an associated output line exceeding a threshold value. The indicator signals may be LED lights, an LED or LCD display and/or alarms sounds. The multi-pump device can pause operation of all pumps in response to pressure in any output line exceeding the threshold value.

In another embodiment of any one of the programable, semi-automatic, multi-task processing systems above, the multi-pump device also includes a nitrogen controller to monitor and regulate the flow of nitrogen into one or more of the column arrays.

Additional embodiments provide a column element for use in a multi-tandem column assembly. The column element includes a first fitting disposed at a first end and a second fitting disposed at a second end. A body of the column element defines a column element interior cavity extending between the first end and the second end. A first frit is disposed at the first end and a second frit is disposed at the second end. The column element also includes first material layer and a second material layer which are separated by an interior frit disposed between the first material layer and the second material layer.

In a further embodiment the column element above, the first fitting is a male luer fitting or a female luer fitting.

In another embodiment of any one of the column elements above, the second fitting is a male luer fitting. The second fitting may be integral with the body.

In a further embodiment of any one of the column elements above, the first material may be selected from silica, carbon, and alumina.

In another embodiment of any one of the column elements above, the first frit is a glass frit and/or the second frit is a glass frit.

In a further embodiment of any one of the column elements above, the column element also includes a Teflon frit disposed at the first end and/or a Teflon frit disposed at the second end.

Additional embodiments provide a method of operating a multi-pump device for a extraction and purification system. The method includes using a controller as a source selector to select a first solvent source of a plurality of solvent sources and selecting at least one pump to move first solvent from the selected first solvent source to an associated output line. A flow rate selector as part of the controller is set in order to select one of a plurality of flow rates at which each enabled pump is to be operated. A first specified duration for a timer or volume is set in the controller so as to operate the selected at least one pump for the specified duration. An output line is attached to assay columns. The method also includes activating the multi-pump device so that the selected at least one pump performs a single purification process task.

In another embodiment of the method above, the purification process task includes conditioning column arrays; sample loading; purification and removal of interferences; and fraction collections.

In a further embodiment of any one of the methods above, conditioning columns arrays includes assembling a tandem column array assembly having a plurality of tandem columns arrays. Each column array being made up of multiple column elements - one of silica, one of alumina and one of carbon. For each of the plurality of tandem column arrays, an output line of an associated pump is attached to the first column element of the associated tandem column array. Activating the multi-pump device moves solvents from a selected solvent source to an associated output line and conditions the tandem column array assembly.

In another embodiment of any one of the methods above, the sample loading includes assembling a loading column array by adding a sample reservoir cartridge to the top of a column array such as, to a first silica column of a tandem column assembly. An output line of Nitrogen is attached to the sample reservoir cartridge. Nitrogen is used to transfer the sample to the tandem column array assembly.

In a further embodiment of any one of the methods above, purification and removal of interferences includes removing a sample cartridge reservoir from each of a plurality of first silica assay column elements. A pump output line is attached to each of the plurality of first silica assay column elements. Activating the multi-pump device moves solvent through the plurality of first silica assay column elements.

In another embodiment of any one of the methods above, fraction collection includes, for each of the plurality of assay columns arrays: detaching the output line from assay column array; detaching a tandem column array assembly by removing carbon and alumina column elements from the tandem column assembly; placing the carbon and alumina column elements in a fraction collection assembly; and attaching an output line to the fraction collection assembly. Activating the multi-pump device moves solvent so as to collect Dioxins from carbon elements and polychlorinated biphenyl (PCB) fractions from alumina column elements. A tandem column array assembly can include at least one silica column element, at least one alumina column element, and at least one carbon column element.

In another embodiment of any one of the methods above, column conditioning, sample loading, purification and fraction collection steps may be performed sequentially to purify and collect dioxins and polychlorinated biphenyl (PCB) from biological, environmental and food samples.

In a further embodiment of any one of the methods above, prior to each processing step, solvent selection, flow rate and duration can be set or modified manually using a controller or pre-programmed for automated processing and repeatable processing steps.

In another embodiment of any one of the methods above, the method also includes assembling a four-assay column array in tandem; attaching an output line to each of the plurality of first assay columns array elements; and enabling pumps associated with the output lines attached to the first assay column elements.

In a further embodiment of any one of the methods above, the method includes, for each of the plurality of assay columns arrays: detaching the output line from the assay columns arrays; removing a collection (one or more) column elements from the assay columns array; assembling a second assay column having the collection of column elements; and attaching an output line to the second assay column array. The method also includes using the source selector to select a second solvent of the plurality of solvent sources; selecting at least one pump configured to move the second solvent from the selected second solvent source to an associated output line; setting a second specified duration for the timer to operate the selected at least one pump; and activating the multi-pump device so that the selected at least one pump is operated for the second specified duration. The first solvent may condition the first assay column array. The second solvent may perform elution and purification of the assay column array. The third solvent may perform fraction collection of assay column array.

In another embodiment, a method is provided for using a solvent delivery system to set up multiple sequences to perform extraction and purification of POP (Persistent Organic Compounds) prior to the analysis, such as by using gas chromatography, liquid chromatography and mass spectrometry. Each sequence can use the solvent delivery system to dispense a given solvent through the selected tandem column array assembly. The solvent delivery system typically includes of a pump, a pressure monitor, an over-pressure detector, a solvent valve selector, a flowrate selector and a volume selector (by setting the duration of delivery). Nitrogen can be selected to deliver the sample to the tandem column assembly from a sample element. The pump can be selected to deliver specified solvents at a specified flowrate for the precise volume to the tandem column assembly. The solvent delivery pressure can be monitored and controlled for over-pressure so that the pressure controller can stop the pump in the case over-pressure is detected.

The combination of multiple sequences can be performed using specific sets of column chromatography to create different extraction and purification methods for POP. As one example, the method may be used for the extraction and purification of dioxins, polychlorinated biphenyl (PCB), pesticides and polycyclic aromatic hydrocarbons (PAHs) analytes. The extraction and purification of dioxins and PCBs can be used with three tandem column array assemblies. The tandem column assembly may include a Silica column element, an Alumina column element, and a Carbon column element.

The method can perform four sequences: column conditioning, sample loading, purification, and fraction collection. Sample loading is performed by using Nitrogen to push the samples through the tandem column array assembly. Then, column conditioning and purification sequences are performed by, for each, selecting an associated solvent, flow rate, and volume (duration) to pass the solvent through the tandem column array assembly in order to condition and/or purify the dioxins. Fraction collection is performed by placing the carbon and alumina columns on a fraction collection manifold and selecting the second solvent, flow rate, and volume (duration) to collect the dioxins and PCBs in separate collection vessels.

The foregoing description has been directed to particular embodiments. However, other variations and modifications may be made to the described embodiments, with the attainment of some or all of their advantages. Modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A programable, semi-automatic and automatic single or multi-task liquid extraction and purification system, comprising:
at least one solvent source;
a programmable controller, fluidly coupled to said at least one solvent source, said programmable controller configured for being pre-programmed program or manually programmed to selectively control the selection of said at least one solvent source and for the provision of the selected at least solvent source under one or more of a user programmable flow rate, time duration and pressure; and
at least one column array, fluidly coupled to said controller, said at least one column array comprising at least one sample containing cartridge fluidly coupled to at least one column element, said at least one column element containing at least one material for use in processing said sample in said sample containing cartridge.

2. The system of claim 1, wherein said system includes a plurality of differing solvent sources.

3. The system of claim 1, further including:
a nitrogen source; and
a two-way valve, fluidly coupled to said nitrogen source and to said at least one solvent source, and electronically coupled to said controller, said two way valve configured for being controlled by said controller to selectively allow one or the other of said nitrogen from said nitrogen source or said solvent from said at least one solvent source to said at least one sample containing cartridge which forms part of said at least one column array.

4. The system of claim 1, wherein said at least one column array includes said at least one sample containing cartridge fluidly coupled to a plurality of column elements containing at least one material for use in processing said sample in said sample containing cartridge, each of said plurality of column elements including an input end and an output end.

5. The system of claim 4, wherein said at least one column array includes:
a nitrogen source;
a first two way valve, fluidly coupled to said nitrogen source and to said at least one solvent source, and electronically coupled to said controller, said two way valve configured for being controlled by said controller to selectively allow one or the other of said nitrogen from said nitrogen source or said solvent from said at least one solvent source to said at least one sample containing cartridge which forms part of said at least one column array;
a first column element containing at least one material for use in processing said sample in said sample containing cartridge, said first column element including an input end and an output end;
a second two way valve, fluidly connected between an output end of said sample containing cartridge and said input end of said first column element and to at least one of said nitrogen source or said at least one solvent source, said second two way valve electronically coupled to said controller, and configured for being controlled by said controller to provide at least one of said nitrogen source or said at least one solvent source to said input end of said first column element; and
a third two way valve, fluidly connected between an output end of said first column element and to one or more of a material collection vessel or a waste vessel, and configured for being controlled by said controller to provide an output from said output end of said first column element to one of said material collection vessel or said waste vessel.

6. The system of claim 1, wherein said at least one column array includes said at least one sample containing cartridge fluidly coupled to a first column element, said first column element containing at least a first material for use in processing said sample in said sample containing cartridge, and wherein said first column element is fluidly coupled to at least a second column element containing at least a second material, different from said first material in said first column element, for use in processing said sample in said sample containing cartridge.

7. The system of claim 1, wherein said at least one column element in said at least one column array contains first and second materials for use in processing said sample in said sample containing cartridge, wherein said first and second materials are separated by a fluid material permeable divider.

8. The system of claim 1, wherein said at least one column element includes a first end and a second end, wherein one of said first and second ends is closed by one of a male or a female fitting, and wherein the other of said first and second ends is closed by the other one of said male or female fitting.

9. The system of claim 1, wherein said at least one column element and said sample containing cartridge are disposable.

10. The system of claim 1, wherein said system includes a plurality of solvent sources, and wherein said programmable controller is fluidly coupled to said plurality of solvent sources and configured for being pre-programmed using a stored program or manually programmed to selectively control the selection of said at least one solvent source from one of a plurality of solvent sources and the provision of the selected at least solvent source under one or more of a user programmable flow rate, volume, time duration, and pressure.

11. The system of claim 1, wherein said at least one column element comprises:
a polytetrafluoroethylene (PTFE) tube body, said tube body defining a column element interior cavity extending between a first end and a second end of said PTFE tube;
a first fitting disposed at said first end of said PTFE tube; and
a second fitting disposed at said second end of said PTFE tube.

12. The system of claim 11, further including:
a first glass frit disposed at the first end fitting of said PTFE tube;
a second glass frit disposed at the second end fitting of said PTFE tube; and
at least a first material layer disposed within said PTFE tube interior cavity.

13. The system of claim 12, wherein said first fitting is one of a male luer fitting or a female luer fitting and wherein the second fitting is one of a male luer fitting or female luer fitting.

14. The system of claim 11, wherein the first and second fittings are permanently pressed into the body of said (PTFE) tube and are integral with the body of said PTFE tube.

15. The system of claim 12, wherein said at least a first material is selected from the group of materials consisting of silica, carbon and alumina.

16. The system of claim 12 wherein said PTFE tube interior includes first and second material, said first and second materials separated by a material separation frit.

17. A method of operating a programable, semi-automatic and automatic single or multi-task liquid extraction and purification system, the method comprising the acts of:
providing a programable, semi-automatic and automatic single or multi-task liquid extraction and purification system comprising:
a plurality of solvent sources;
a programmable controller, fluidly coupled to said at least one solvent source, said programmable controller configured for being pre-programmed program or manually programmed to selectively control the selection of said at least one solvent source and for the provision of the selected at least solvent source under one or more of a user programmable flow rate, time duration and pressure; and
at least one column array, fluidly coupled to said controller, said at least one column array comprising at least one sample containing cartridge fluidly coupled to at least one column element, said at least one column element containing at least one material for use in processing said sample in said sample containing cartridge;
said method further comprising:
using said programmable controller to select a first solvent source from said a plurality of solvent sources, said act of using said controller to select a first solvent source from said a plurality of solvent sources including said controller operating a valve coupled to said first solvent source;
using said programmable controller to select at least one pump configured to move said selected first solvent from the selected first solvent source to an associated output line;
using said programmable controller to select a flow rate for at least one pump for said first solvent;
using said programmable controller to set at least one of a specified time duration or a specified solvent volume for which said at least one pump will operate; and
attaching an output line from said programmable controller to an assay column array; and using said programmable controller, activating the at least one pump to perform a single purification process task.

18. The method of claim 17, wherein the purification process task comprises one or more of the following steps:
conditioning one or more assay column arrays;
sample loading of one or more assay column arrays;
purification and removal of interferences in said one or more conditioned and sample loaded assay column arrays; and
collecting fractions from said one or more assay column arrays.

19. The method of claim 18, wherein said step of conditioning, sample loading, purification and fraction collection is performed one task at a time using one or more assay column arrays and includes the acts of:
assembling at least one sample cartridge,
assembling at least one column array including said assembled sample cartridge and further including a plurality of column array elements, each column array element containing one or more of silica, alumina and carbon; and
for each of the assembled column arrays, attaching an output line of an associated solvent pump to a first column element of an assembled column array;
activating said associated solvent pump to move a selected solvent from a selected first solvent source to an associated output line; and
conditioning the column array using said first solvent.

20. The method of claim 18 wherein the act of sample loading comprises:
attaching an output line of a nitrogen or solvent pump to the at least one sample containing cartridge; and
using one or both of said nitrogen or solvent pump to transfer the samples from the sample cartridge to the column array.

21. The method of claim 18, wherein said act of purification comprises:
attaching a pump output line to each of a plurality of silica containing assay column elements; and
activating at least one pump device to move solvent through the plurality of assay column elements.

22. The method of claim 19 wherein the column array elements include a silica column element, a carbon column element and an alumina column element, and wherein the method includes conditioning the column elements, loading the samples in the sample cartridge, perform purification and collecting Dioxins from the carbon column elements and polychlorinated biphenyl (PCB) fractions from the alumina column elements.

23. A sample cartridge reservoir comprising :
a cartridge tube;
a embedded male fitting at a first end of said cartridge tube;
a removable cartridge cap at a second end of said cartridge tub, said removable cartridge cap including a o-ring seal;
a body defining a cartridge element interior cavity extending between the first end and the second end; and
a first frit disposed at the first end proximate said embedded male fitting.

24. The sample cartridge reservoir of claim 23, wherein the embedded male fitting is a male luer fitting.

25. The sample cartridge reservoir of claim 23, wherein the removable cartridge endcap fitting is a female luer fitting.

26. The sample cartridge reservoir of claim 25 wherein the removable cartridge cap with associated o-ring seals the cartridge by placing the endcap over the second end of cartridge and twisting the end cap approximately 90 degrees.
